(19) United States
(12) Patent Application Publication
(10) Pub. No.: US 2009/0031302 A1
(43) Pub. Date: Jan. 29, 2009

(54) METHOD FOR MINIMIZING RISKS OF CHANGE IN A PHYSICAL SYSTEM CONFIGURATION

(75) Inventors: Mandis S. Beigi, White Plains, NY (US); James E. Hanson, Yorktown Heights, NY (US); Parviz Kermani, South Salem, NY (US); Dinesh C. Verma, Mount Kisco, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/782,378

(22) Filed: Jul. 24, 2007

(51) Int. Cl. G06F 9/455

(52) U.S. Cl. 718/1

(57) ABSTRACT

Risks of change to a physical configuration are minimized. A request for a change to the physical system included in the physical configuration is detected, and all applications the physical systems that would be affected by the requested change are identified. All the applications and physical systems that would be affected by the requested change are replicated on a virtual system, including applications and the physical system to which the requested change is targeted and applications and physical systems that are dependent on the applications and the physical system to which the requested change is targeted. The requested change is applied to the virtual system. The virtual system is tested to determine whether the applied change produces desired results. If the applied change products the desired results, the requested change is applied to the physical system.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

The present invention relates generally to changes in system configuration, and, more particularly,to minimizing risks of changes to system configurations.

A major problem in today's information technology (IT) world is the lack of administrators' knowledge of the inner workings of complex business applications that support their businesses. The administrators are often hesitant to fix or change anything, as one fix could break something in the complex intertwined IT infrastructure. For example, a patch to fix a security flaw in an application server at one end may break an on-line ordering application that utilizes the same server at the other end.

### SUMMARY

According to an exemplary embodiment, a method is provided for minimizing risks of change to a physical configuration including a physical system having physical machines on which applications are running. A request for a change to the physical system is detected, and all applications and other physical systems that would be affected by the requested change are identified. All the applications and physical systems that would be affected by the requested change are replicated on a virtual system, including applications and the physical system to which the requested change is targeted and applications and physical systems that are dependent on the applications and the physical system to which the requested change is targeted. The requested is applied to the virtual system. The virtual system is tested to determine whether the applied change produces desired results. If the applied change produces the desired results, the requested change is applied to the physical system. Otherwise, a system administrator is informed of the test failure.

### BRIEF DESCRIPTION OF THE DRAWINGS

Referring to the exemplary drawings, wherein like elements are numbered alike in the several Figures:

FIG. 1 illustrates mapping of a physical environment/system to a virtual environment/system according to one aspect an exemplary embodiment.

FIG. 2 illustrates mapping of a physical environment/system to a virtual environment/system, according to another aspect of the exemplary embodiment.

FIG. 3 illustrates a method for minimizing risks of change in a physical system using replication of the physical system in a virtual system to an exemplary embodiment.

### DETAILED DESCRIPTION

According to an exemplary embodiment, a method is provided for minimizing the risk of configuring a physical system of making changes to the physical system such that the change does not result in problems within a current setup of the physical system environment. A mechanism is provided that enables critical changes to a system to trigger a set of automatic checks. Before the change is accepted, the physical system is replicated using a set of virtual machines, and a series of tests are run on the virtual machines. Once all the tests are passed, the change is accepted and applied to the physical system. Otherwise, the administrator is notified of the problem that the change will cause. This enables administrators to test changes and understand the implications on th physical system before rolling the changes out.

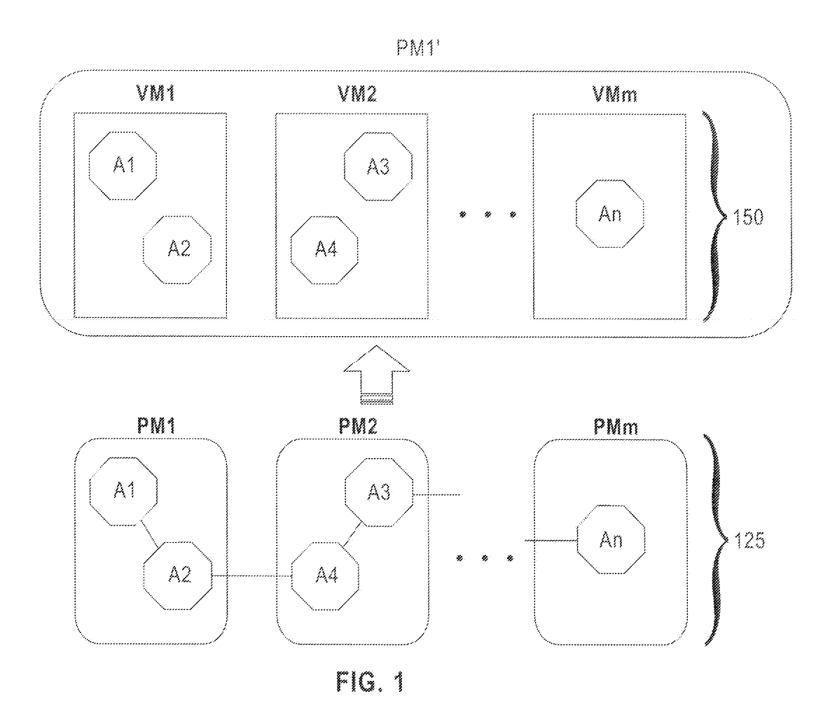

FIG. 1 illustrates a physical environment/system 125 including m physical machines (PM1, PM2, . . . , PMm) with one or more applications (A1, A2, . . . An) running on the physical machines. For example, as shown in FIG. 1, applications A1 and A2 run on PM1, while applications A3 and A4 run on PM2. FIG. 1 also illustrates a virtual environment 150 including m virtual machines (VM1, VM2, . . . , VMm) running on a single physical machine PM1′, with each virtual machine running one or more applications (A1, A2, . . . An). For example, as shown in FIG. 1, application A1 and A2 run on virtual machine VM1, while applications A3 and A4 run on virtual machine VM2. Lines connecting the applications running on the physical machine, such as the line connecting applications A2 and A4, show the dependencies between the applications. If a request is received for configuring or changing the physical environment 125, the virtual environment 150 is created as a substantially exact copy, including all the applications affected by the configuration/change.

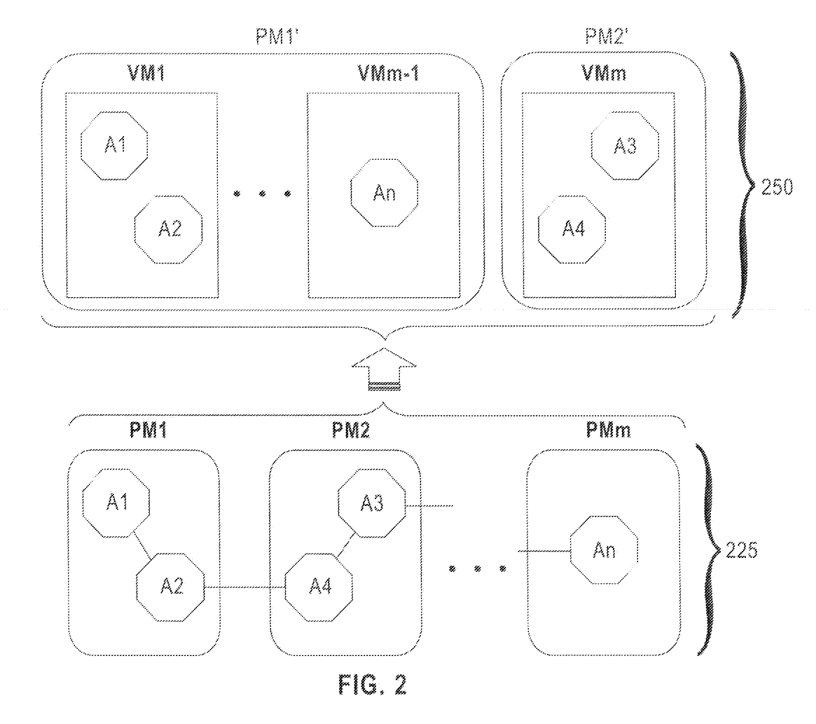

FIG. 2 illustrates another scenario in which the copy of the physical environment is created on a virtual environment running on more than one physical machine. FIG. 2 illustrates a physical environment/system 225 including m physical machines (PM1, PM2, . . . , PMm) with one or more applications (A1, A2, . . . An) running on the physical machine. For example, as shown in FIG. 2, applications A1 and A2 run on physical machine PM1. Lines connecting the applications running on the physical machine, such as the line connecting applications A2 and A4, show the dependencies between the applications. FIG. 2 also illustrates a virtual environment 250 including m-1 virtual machines (VM1, . . . , VMm-1) running on a physical machine PM1′ and one virtual machine (VMm) running on a separate physical machine PM2′ with each virtual machine running one or more application (A1, A2, . . . , An). For example, as shown in FIG. 2, virtual machine VM1 runs applications A1 and A2, while virtual machine VMm runs applications A3 and A4. Although the scenario in FIG. 2 shows a virtual environment in which the physical environment is replicated as two different physical machines, it should be appreciated that the physical environment may be replicated in the virtual environment using any number of physical machines.

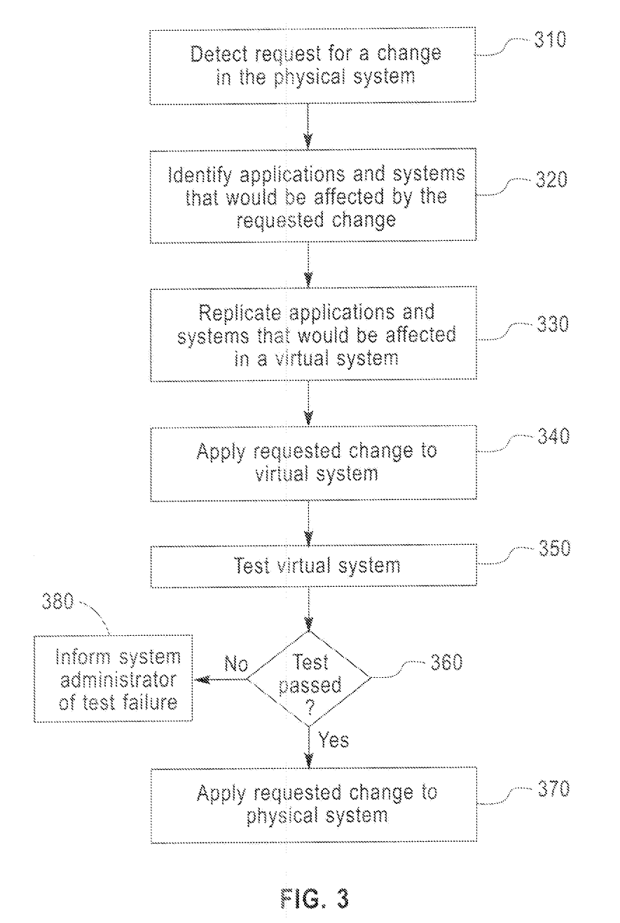

FIG. 3 illustrates a method for minimizing risks to changes in a physical system using replication of the physical system in a virtual system according to and exemplary embodiment. The method includes a series of steps that may be taken in response to a request from an administrator received, e.g., through a management console. Referring to FIG. 3, a request for a change in the physical system is detected at step 310. The request may be for changing the physical system, e.g., applying a security patch, updating an application, or changing a configuration parameter, or for initially configuring the physical system.

At step 320, all applications and systems that would be affected by the requested change are determined. These may include applications and systems that are dependent on the applications/system to which the request is targeted as well as the applications/system for which the change is requested. If there are applications on the physical system that are dependent on other applications on other physical systems, then those physical systems are also dependent. For example, if the change would affect an application server that connects to a database on another physical system, then that other physical system would be dependent on the physical system to which the requested change is targeted. The dependent applications could also just lie in the same physical system, and in that case, there is no dependency on other physical systems.

At step 330, the applications and systems that would be affected are replicated in a virtual system. This step may be performed upon demand, in response to the request for the change, or in advance, as discussed below. This replication may ba performed in an emulation server environment. The topology of the physical system may be discovered through a discovery too, such as Collation. Emulation may then be done by mapping each physical device in the physical system into a virtual machine running on an emulation server. The configuration information and installation package for this operation may be obtained by creating clones of the installation package that is on a physical server in the physical system.

The requested change is applied to the virtual system in the emulation environment at step 340. A validation test is applied to the virtual system at step 350. In order to run the performance related test, the clock of the virtual machine(s) may be adjusted to simulate the physical machine(s). The validation test performed in step 350 may be performed using a set of predefined diagnostics. Alternatively, the validation test may be performed by capturing the input requests/logs made on the physical system, as well as the corresponding responses, and replaying those requests on the virtual system to validate that the correct responses are obtained.

A determination is made at step 360 whether the test succeeds, i.e., whether the virtual system produces the desired results. If so, the requested change is applied to the physical system at step 370. Otherwise, the administrator may be notified of the change at step 380.

Although the steps in FIG. 3 are shown in a particular order, it should be appreciated that this order is given by way of example only. For instance, though step 330 described above indicates that the virtual system is created after identifying applications and/or systems that would be affected by the requested change, the virtual system may be set up in advance as a replica of the physical system. In this case, the entire physical system is replicated in the virtual system, along with all dependent systems. This would make system rollover faster.

According to exemplary embodiments, a mechanism is provided to help administrators in performing changes to a system by knowing in advance what the impact of the change will be. Such a mechanism minimize the problems produced as a result of misconfigurations and changes to a system and therefore reduces the time and cost of problem determination and system management. Such a mechanism also reassures the administrators that is is okay to proceed with changes providing them with the confidence that the changes they are about to make will not produce new problems.

While an exemplary embodiment has been described above, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it it intended that the invention not be limited to the particular embodiment disclosed as the best mode contemplated for carrying out this invention, but that the invention will include all embodiments falling within the scope of the appended claims.

What is claimed is:

1. A method for minimizing risks of change to a physical configuration including a physical system having physical machines on which applications are running, the method comprising:
detecting a request for a change to the physical system;
identifying any applications and physical systems that would be affected by the requested change, wherein the applications and physical systems that would be affected by the requested change include applications and the physical system to which the requested change is targeted and applications and physical systems that are dependent on the applications and the physical systems to which requested change is targeted;
replicating the applications and physical systems that would be affected by the requested change on a virtual system;
applying the requested change to the virtual system;
testing the virtual system to determine whether the applied change produces desired results;
if the applied change produces the desired results, applying the requested change to the physical system; and
if the applied change does not produce the desired results, informing a system administrator that the test failed.

2. The method of claim 1, wherein the virtual system is set up as a replica of the physical system prior to receipt of the request for a change to the physical system.

3. The method of claim 1, wherein the virtual system is set up on demand upon detection of requested change.

4. The method of claim 1, wherein the requested change includes at least one of a system patch, an application upgrade, a change in a configuration parameter, or a physical system configuration set-up.

5. The method of claim 1, wherein the physical system includes m physical machines with one or more application running on each physical machine, and the virtual system includes m virtual machines running on another physical machine, with one or more applications running on each virtual machine, wherein m is an integer greater than or equal to 1.

6. The method of claim 1, where the physical system includes m machines with one or more applications running one each physical machine, and the virtual system includes m-1 virtual machines running on m-1 other physical machines and one virtual machine running an another physical machine, with one or more applications running on each virtual machine, wherein m is an integer greater than or equal to 1.
